(19) United States
(12) Patent Application Publication
(10) Pub. No.: US 2021/0314621 A1
(43) Pub. Date: Oct. 7, 2021

(54) METHOD AND APPARATUS FOR TILED WAVELET IMAGE ENCODING AND DECODING

(71) Applicant: Teradici Corporation, Burnaby (CA)

(72) Inventors: Kevin Howard Betts, Port Coquitlam (CA); David Victor Hobbs, Surrey (CA); Victor Lee, Port Coquitlam (CA); Kevin Mlazgar, Vancouver (CA)

(21) Appl. No.: 17/225,055

(22) Filed: Apr. 7, 2021

Related U.S. Application Data
(60) Provisional application No. 63/006,307, filed on Apr. 7, 2020.

(51) Int. Cl. H04N 19/635; H04N 19/61; H04N 19/172

(52) U.S. Cl. CPC H04N 19/635; H04N 19/172; H04N 19/61

(57) ABSTRACT

A method and apparatus for encoding an image. In one embodiment, the method comprises encoding, using a tiled Cohen-Daubechies-Feauveau (CDF) filter, a plurality of tiles of the image, wherein update step results of one tile edge of a first tile of the plurality of tiles are used as inputs to a predict step of an adjacent tile edge.

### CROSS-REFERENCE TO RELATED APPLICATIONS

This application claims benefit of U.S. provisional patent application Ser. No. 63/006,307, titled “Method and Apparatus for Tiled Wavelet Image Encoding”, filed Apr. 7, 2020, which is herein incorporated in its entirety by reference.

### BACKGROUND OF THE INVENTION

### Field of the Invention

Embodiments of the present invention relate generally to a method and apparatus for tiled wavelet encoding and decoding of image frame sequences where tiles of a frame having mixed content may require multiple different encoding methods such as build to lossless or text specific encoding (e.g., for a desktop display image; or remoted displays connected to a bandwidth-limited communication network and requiring updates to portions of the display while other portions of the display remain constant, such as a display showing updating computer-generated status information in combination with video content).

### Description of the Related Art

The JPEG200 specification describes a wavelet image compression technique whereby a source image is partitioned into tiles and each tile is separately subjected to a wavelet transform process. A problem with such an approach is that the decoded image is subject to blocking artifacts visible at tile boundaries. These blocking artifacts become more visible as compression of transformed coefficients increases to meet communication bandwidth constraints. Full frame wavelet processing of the source image mitigates such blocking distortions, but full frame processing is unsuitable for mixed content source images, such as computer desktop display images. The compression techniques best suited for such mixed content images are dictated by image content type and image recent change status. As an example, text content is typically better suited to some spatial domain coding than only frequency domain coding. Furthermore, it is inefficient to recompress and retransmit unchanged areas of a desktop display image to accommodate a small change in one portion of an image frame.

Typical discrete wavelet-based compression techniques involve preforming a convolution across the image with a wavelet function. The blocking artifact errors are caused by performing the convolution along the block (tile) edge where some of the wavelet coefficients are outside the current image tile. This discontinuity introduces noise along boundary. This blocking artifact is commonly referred to as “boundary effects”. Some of the common approaches to reduce blocking artifacts are zero padding, dc padding and symmetric padding. The problem with current padding approaches is that they will only work for certain images, and all padding approaches will show artifacts for certain images.

One solution to mitigating blocking artifacts involves over-scan of the pixel areas of candidate compression tiles which reduces artifacts related to reflecting coefficients at block boundaries. However, in addition to reducing compression by encoding unused image data, efficient vectorization and processing of a selection of candidate tiles spread arbitrarily over an image remains problematic, particularly in cases where it is desired to maximize the data parallelism offered by vector processing extensions offered by modern processors. Therefore, there is a need in the art for a tile wavelet-based processing technique suitable for mixed content images and architected for improved performance when using vector processing extensions.

### SUMMARY OF THE INVENTION

Embodiments of the present invention generally relate to a method and apparatus for encoding mixed content images with natural (e.g. picture) and rendered (e.g. text) constant and changing content, such as a desktop display image, substantially as shown and/or described in connection with at least one of the figures, or as set forth in the example claims.

More specifically embodiments of the invention relate to methods and apparatus for saving intermediate transformed coefficients of one tile of a first frame to facilitate the encoding and decoding of wavelet data of an adjacent tile, which may be in the first frame or a second frame. This method is referred to herein as a saved-over-scan (SOS) transform.

Other embodiments of the invention relate to combining combinations of wavelet-encoded images with other encoded images to encode complex mixed content images.

Various advantages, aspects and novel features of the present disclosure, as well as details of an illustrated embodiment thereof, will be more fully understood from the following description and drawings.

### BRIEF DESCRIPTION OF THE DRAWINGS

FIG. 1 illustrates selected details of an embodiment of a system comprising a host computer with a lossless and a lossy image codec encoder communicatively coupled to, and enabled to communicate with, a client computer;

FIG. 2 illustrates a source image with changed and unchanged LY (lossy) and LL (lossless) content regions in accordance with embodiments of the present invention;

FIG. 3 illustrates a single dimension of a two-dimensional multi tile wavelet decomposition supporting selective tile updates in accordance with embodiments of the present invention;

FIG. 4 illustrates a single dimension of a two-dimensional multi tile wavelet composition supporting selective tile updates in accordance with embodiments of the present invention;

FIG. 5 illustrates an encoding of a text tile in accordance with embodiments of the present invention;

FIG. 6 illustrates a mixed content tile with building to lossless unchanged content, in composition with, changing content in accordance with embodiments of the present invention;

FIG. 7 is a flow diagram of a method for encoding an image sequence in accordance with embodiments of the present invention; and

FIG. 8 is a flow diagram of a method for decoding an encoded image sequence in accordance with embodiments of the present invention.

### DETAILED DESCRIPTION

Embodiments of the invention may be implemented in numerous ways, including as a process, an article of manufacture, an apparatus, a system, and as a set of computer-readable descriptions and/or instructions embedded on and/or in a non-transient computer-readable medium such as a computer-readable storage medium. In this specification, these implementations, or any other form that the invention may take, may be referred to as techniques. The Detailed Description provides an exposition of one or more embodiments of the invention that enable improvements in features such as performance, power utilization, cost, scalability, efficiency, and utility of use in the field identified above. The Detailed Description includes an Introduction to facilitate the more rapid understanding of the remainder of the Detailed Description. Embodiments of the invention encompasses all possible modifications and variations within the scope of the issued claims.

The term processor as used herein refers to any type of processor, central processing unit (CPU), microprocessor, microcontroller, embedded processor, media processor, graphics processor, or any other programmable device capable of executing and/or interpreting instructions in a form of software (such as microcode, firmware and/or programs).

The term software as used herein refers to any type of computer-executable instructions for any type of processor, such as programs, applications, scripts, drivers, operating systems, firmware, and microcode. Computer-executable instructions include any types of instructions performed by a processor, such as binary instructions that are directly performed, instructions that are translated and/or decoded prior to being performed, and instructions that are interpreted.

### Introduction Image

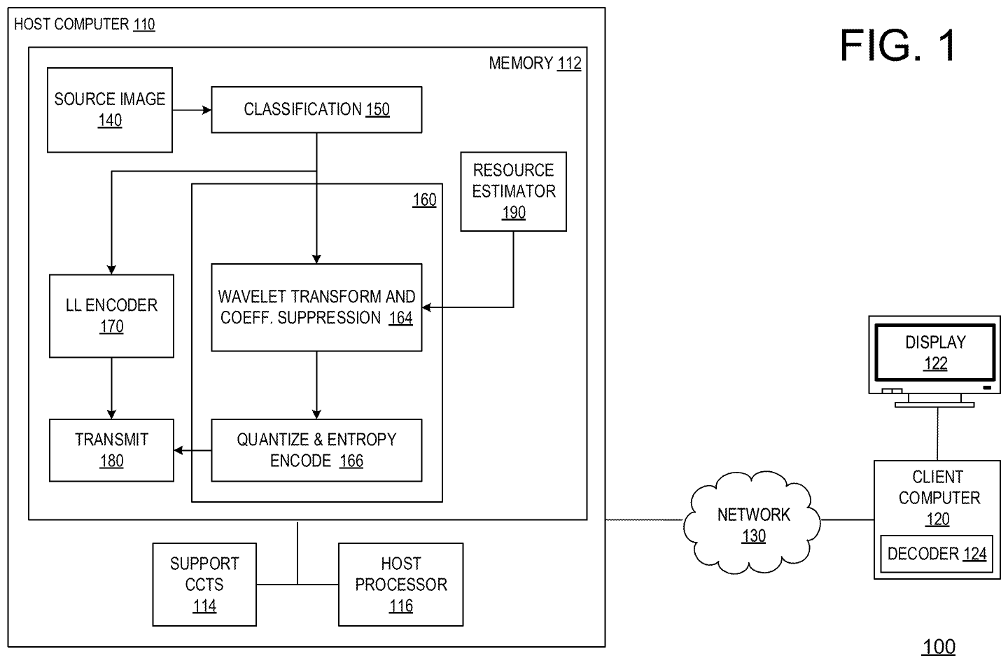

In one or more embodiments of the present invention, a remote computing system, such as system 100 in FIG. 1, comprises a host computer coupled via a network to a client computer with a display. Software applications on the host computer, in conjunction with an operating system, produce a sequence of mixed content image updates (i.e., an image sequence comprising content such as background, text, natural images and high detail objects) rendered as pixel values to a frame buffer in system memory. Some of the content (including natural images and high detail objects) may be associated with a video player application and changes at a periodic source frame rate (e.g., 24 frames per second). Other content may change sporadically or persistently in response to user input, for example a photo viewer, a Computer Aided Design (CAD) application, a video image rendering application or word processing document under control of scroll bars, pointer input a dragged application frame or other human or automated input devices.

Rather than, or in addition to, displaying the image sequence locally at the host computer, the updates to the image sequence are encoded at the host computer using, in part, a tile-based wavelet encoding technique as described herein and transmitted to the client computer.

Content of a candidate frame of the source image (e.g. pixels, blocks, or other defined regions) may also be classified as either i) “LL (lossless) content” (e.g. text, high contrast or constant content) suitable for one or more of spatial domain encoding, increase quality lossy encoding, lossless or layered encoding, or ii) “LY (lossy) content” suited to frequency domain or lossy encoding.

In an embodiment, text content in an artificial image is identified as high-contrasting pixels set on an artificial low-contrast background or a constant color background. Furthermore, text content has repeat colors (e.g. background colors). Such high-contrast text pixels are typically encoded, in part or whole, using a lossless encoding technique in the red, green and blue (RGB) color space which provides a higher compression ratio than changing the color space. High contrast text pixels may also be encoded in part using a lossy technique, although frequency domain encoding is generally avoided or augmented to prevent or remove Gibbs ringing effects. The “LY” content (e.g. natural image content with high color diversity) is suitable for wavelet encoding.

LY content at a defined screen location is further classified as either ‘changed’, or ‘unchanged’, subsequent to previous content at the same screen location. Unchanged content may include identical RGB pixel values in the source image. In an embodiment using a fixed grid of tile boundaries (tile boundaries), a boundary between changed and unchanged image content (content boundary), rarely aligns with one of the tile boundaries, requiring some changed encoded tiles to be both changed and unchanged (e.g. quality build) encoded with a content boundary mask.

Other content-specific variations may include RGB color space limitations, pixel masking, or codec selection.

### Reducing Blocking Artifacts of Tile Based Wavelet Encoding

Encoding content using a wavelet codec in combination with reflecting the transform at the tile boundaries is known to generate blocking artifacts that increase as the compression is increased. Embodiments of the present invention, which mitigate such artifacts, include a method of saving coefficients of a tile encoding (and a tile decoding) for use in encoding (and decoding) an adjacent tile. By orienting the tile wavelet-encoding transform to maximize the image quality of the tile edge in the direction of a tile encoding progression, saved coefficients of the previously-encoded adjacent tile are used in the wavelet encoding (and decoding) of the trailing edge of the adjacent tile. To maximize the image quality, all leading tile edge coefficients, including intermediate lifting coefficients, are saved and used in the encoding and decoding of the following adjacent tile. This method of using saved coefficients of an otherwise isolated previously-encoded tile is referred to herein as Saved-Over-Scan or SOS encoding.

In the decoding of encoded tiles, the same method of saving leading edge decoding coefficients and using them in the decoding of the subsequent adjacent tile decoding is used, although in some embodiments the coefficients received at the decoder have been quantized for compression and have lost some accuracy when decompressed. While this will introduce some errors, the errors are minor compared to the blocking artifact errors of an isolated tile quantized wavelet decoding.

In an embodiment, where adjacent leading and following tiles are encoded and decoded, and the leading tile is changed and re-encoded, the following tiles must be re-encoded and decoded, even if the following tiles have not changed, to minimized blocking artifacts. This applies to re-encoding the leading tile due to a change in the image or a change in compression quantization level. Similarly, when a tile is lost due to a communication error between the encoder and decoder, retransmitting an encoding of the lost tile requires transmitting at least three adjacent tiles in the forward encode direction where the lost tile re-encoding shares coefficients with adjacent tiles.

Typically, a frame is divided into a grid of common size tiles and processed in a left-to-right and top-to-bottom raster encoding and decoding order. Using this arrangement, all tiles except the bottom right tile share coefficients with at least one other tile. It also means a change in a tile requires the re-encoding and decoding of at least four tiles to propagate the changes of the one changed tile and minimize the blocking artifacts. In the technique described herein, one tile is fully transformed all frequencies before the adjacent tile starts its transform, which allows an individual tile to be updated; in 2-dimensional transforms, a tile must have either a frame boundary or a previously encoded tile on two adjacent sides of the tile to be encoded.

Typically, encoding the tile to the right, the tile below, and the tile to the below right is sufficient to encode the changes to one tile as these are the tiles that share coefficients in a continuous 5/3 wavelet transform. However, larger transforms propagate the effects of each coefficient further and would require more tiles to be re-encoded when one tile changes.

In an embodiment with a multi-threaded codec solution where each tile row is processed by a different thread, each thread must check to see that the above tile has completed encoding/decoding and generated the required shared coefficients before encoding/decoding the associated current tile. Alternatively, a frame can be divided into multiple rectangles, where each rectangle is processed by multiple threads. However, this requires the re-encoding/decoding of the top and left shared edges of the rectangles to incorporate the missed shared coefficients.

In an embodiment, a tile of an image that is unchanged can be built to a lossless decoded image by sending additional layers of less-quantized wavelet encoded image data until all quantization is removed. However, an adjacent tile to a lossless building tile that is not lossless and is sharing a coefficient with the lossless building tile will prevent the lossless building tile from being truly lossless. To support a true build to lossless, the tile that is encoding to lossless may change its wavelet to an isolated tile wavelet, at a defined quality level, that doesn't use adjacent tile coefficients and then continue to build to true lossless. The tile will continue to save intermediate leading tile edge coefficients to be used by adjacent tiles that might not be encoded to lossless.

In an embodiment, blocking artifacts can be further reduced at non-lossless quality settings by decreasing the quantization (increasing the accuracy) of leading-edge high-frequency coefficients shared with the adjacent tile.

With traditional tile-based wavelet encoding and decoding of a tile, intermediate transform coefficients may be discarded and only the latest quality coefficients are saved. In contrast, with the SOS encoding described herein, a tile decode is based on saved adjacent intermediate decoded data that must be saved and reused if the tile changes. This is where the Saved Over Scan (SOS) name comes from.

As each successive tile encode requires content from two adjacent previously encoded tiles, multi-threaded encoding and decoding must ensure correct encoding sequencing.

### FIG. 1 Remote Computing or Display System

FIG. 1 illustrates selected details of an embodiment of a remote computing or remote display system 100 (“system 100”) for remote display of a computer readable image. System 100 comprises a host computer 110, such as a personal computer, a virtualized computer, a cloud computer, a workstation, or the like, communicatively coupled to (by for example an Internet Protocol (IP) packet network 130) and enabled to communicate with one or more communication endpoints, such as a decoder integrated display or client computer 120. In a virtualized environment such as a virtualized desktop infrastructure (VDI) or desktop-as-a-service (DaaS) deployment, system 100 comprises many integrated displays and/or client computers in communication with the host computer 110 via network 130.

Host computer 110 (“computer 110”) is, generally, a computer or system of computers designated for running application software such as word processor, spreadsheet application, Computer Aided Design (CAD) software, digital photo viewer, video player software, and the like, and generating a visual user interface, i.e., a source image 140 stored as an ephemeral set of pixel values in a two-dimensional memory buffer of memory 112. The source image 140 may comprise a host-rendered desktop display image, or a host-rendered published application display image which is updated in response to events such as user input, application updates or operating system events. According to embodiments of the present invention, a consecutive series of such updates to source image 140 is referred to as an ‘image sequence’. The host computer 110 comprises the host processor 116 which, in various embodiments, comprises one or more central processing units (CPUs or cores), one or more graphics processing units (GPUs) or no GPUs, or a combination of CPU and GPU processing elements communicatively coupled to memory 112. The host computer 110 further comprises support circuits 114, coupled to the host processor 116 and the memory 112, such as power supplies, data registers, network interface and the like that enable various functions such as communications between the elements of computer 110 in addition to communications between host computer 110 and the network 130.

The classification function 150 within the memory 112 classifies the source image 140 according to content characteristics and change status. Regions such as text, high-contrast regions or background regions of color sparsity (i.e. a low color count in a defined area) are designated as IL′ regions which are earmarked for high-quality encoding (i.e. encoding to a lossless or perceptually lossless quality). Regions such as natural image content (e.g. regions of a photograph), or regions of low contrast or regions of high color variety are earmarked for ‘LY’ lossy encoding using the wavelet encoding techniques described herein. Classification function 150 further designates image regions as either ‘changed’ or ‘unchanged’. After pixels of source image 140 have been updated by a drawing operation or other image source content, the updated pixels are classified as ‘changed’ pixels. Once a ‘changed’ pixel or region has been encoded and transmitted (which may entail multiple progressive encoding iterations), it is re-classified as ‘unchanged’ until the pixel location is once again updated with a new value. This prevents retransmission of previously transmitted content. Furthermore, unnecessary CPU processing costs such as color space conversion or sum-of-absolute-difference (SAD) calculations that might result from p-frame encoding (i.e. video frame difference encoding) with zero difference are prevented. Because large desktop displays are typified by relatively small changed areas compared to a full frame image update typical of a video frame, continuous full frame video coding is inefficient. If a video codec is deployed, significant processing is wasted in the process of identifying the unchanged regions which are inevitably subjected to ‘skip’ encoding.

In an embodiment, changed pixels that have been classified as LY are encoded to a specified image quality level using a progressive encoding technique. In different embodiments, the specified resting quality of the transmitted pixel may be lower than the source pixel (i.e. lossy encoding) or identical to the source pixel, i.e. progressive refinement to lossless encoding. Such progressive refinement steps may be executed in stages. For example, a changed pixel or region may be increased to a first resting quality as a priority and then the quality of individual unchanged LY content sub-regions are refined from present quality levels to higher quality levels than the changed LY content.

The LY encoder 160 comprises wavelet transform and coefficient suppression function 164 (which may be referred to as module 164), and quantization and entropy encoding function 166 (which may be referred to as module 166). LY content is typically subjected to two transformations as part of the encoding process. Initially, content is subjected to color space conversion such as RGB to YUV conversion or alternative luminance and chroma color space conversion. Secondly, the space-converted data is transformed from spatial to frequency domains. These transformations, which work well for natural images, improve the perceived image quality for a determined data bit rate by removing image content that is less visible to human perception. However, such transformations generate artifacts in high contrast computer generated image content such as text.

A boundary process fills regions that participate in the wavelet transform but are outside of the image frame with coefficient data that minimizes the size of the encoded data set while also allowing the transform to proceed with the same steps as when a full image is processed. In different embodiments, such region filling is accomplished using wavelet signal extension operations such as periodic replication, mirror-image replication, zero padding or linear extrapolation.

The quantization and entropy encoding function 166 quantizes the coefficients according to quality requirements, for example as determined by resource estimator 190. In an embodiment, the resource estimator 190 evaluates network or CPU resource constraints and adjusts the quality accordingly. The quantization and entropy encoding function 166 uses an arithmetic encoder to compress the quantized coefficients.

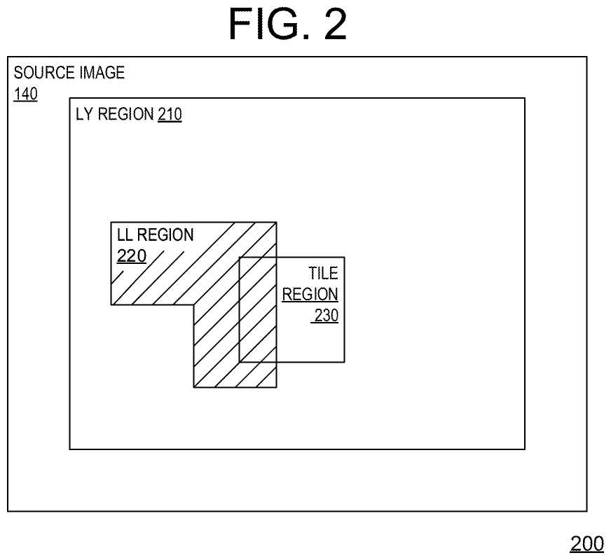

The LL encoder 170 uses a lossless encoder such as a dictionary encoder and/or a lossless quality setting lossy encoder to compress regions comprising text and background content that have been designated as LL regions (e.g., shown as LL region 220 in FIG. 2). Direct to lossless embodiments of the LL encoder 170 use dictionary encoding methods such as an historic reference encoder (e.g. Zlib) or a fixed or adaptive palette encoder or a bit mask encoder (e.g. background/text mask), or combinations of encoders.

In some embodiments, at least LL encoder 170, wavelet transform and coefficient suppression module 164 and quantize and entropy encode module 166 are features of the same codec with masking to temporally and spatially separate different encodings of source image, and the LL encoder 170 maintains multiple temporal and spatial frame data structures for different encoding methods and quality settings to match content with available network bandwidth.

In some embodiments, at least part of the LY encoder 160 and the LL encoder 170 are implemented as one or more hardware accelerator functions such as part of an application specific integrated circuit (ASIC) or field programmable gate array (FPGA) with access to the memory 112. Such a hardware accelerator function may comprise memory resources, image classification and encoding functions in addition to stream assembly functions for encoding and transmitting source image 140 and other source images generated by the host processor 116. In other embodiments, the LY encoder 160 and the LL encoder 170 are implemented, at least in part, as a set of machine executable instructions stored in memory 112 and executed by the host processor 116.

The transmit function 180 (module 180) provides services for encapsulating and transmitting the encoded data generated by LL encoder 160 and LY encoder 170.

The network 130 comprises a communication system (e.g., local area network (LAN), wireless LAN, wide area network (WAN), and the like) that connects computer systems completely by wire, cable, fiber optic, and/or wireless links facilitated by various types of well-known network elements, such as hubs, switches, routers, and the like. In one embodiment, the network 130 may be a shared packet switched network that employs various well-known protocols (e.g., TCP/IP, UDP/IP and the like) to communicate information amongst the network resources. For example, in various embodiments, the network 130 employs part of the Internet.

The client computer 120 (“client 120”) is generally any type of computing device that can connect to network 130 and decode the compressed source image for display on display 122. For example, in an embodiment, client 120 is a terminal such as a zero client, thin client, personal computer, a digital signage device or tablet device. Client 120 typically comprises one or more peripheral devices such as a mouse, keyboard or touch interface and a display 122 for presenting a remote Graphical User Interface (GUI). The image decoder 124 (‘decoder 124’) of client computer 120 comprises image decoder functions such as lossless decompression, inverse quantization and inverted transform functions complementary to those of LY encoder 160 and LL encoder 170. In some embodiments, the decoder 124 is implemented, at least in part, as a set of machine executable instructions executed by the CPU of client computer 120. In other embodiments, the decoder 124 is implemented at least in part as a hardware accelerator function such as part of an application specific integrated circuit (ASIC) or field programmable gate array (FPGA) with memory and a display interface.

### FIG. 2 Source Image Regions

FIG. 2 illustrates a conceptual depiction 200 of the source image 140 in accordance with embodiments of the present invention. As shown in FIG. 2, the source image 140 comprises an LY region 210, an LL regions 220, and a tile region 230. The portion of the source image 140 designated as the LY region 210 is classified as comprising LY content. The shaded LL region 220, which is bounded by the LY region 210, is classified as comprising LL content. Tile region 230, within the LY region 210, is an exemplary image tile comprising both a lossy and lossless region (i.e., a portion of the tile region 230 is within the LL region 210).

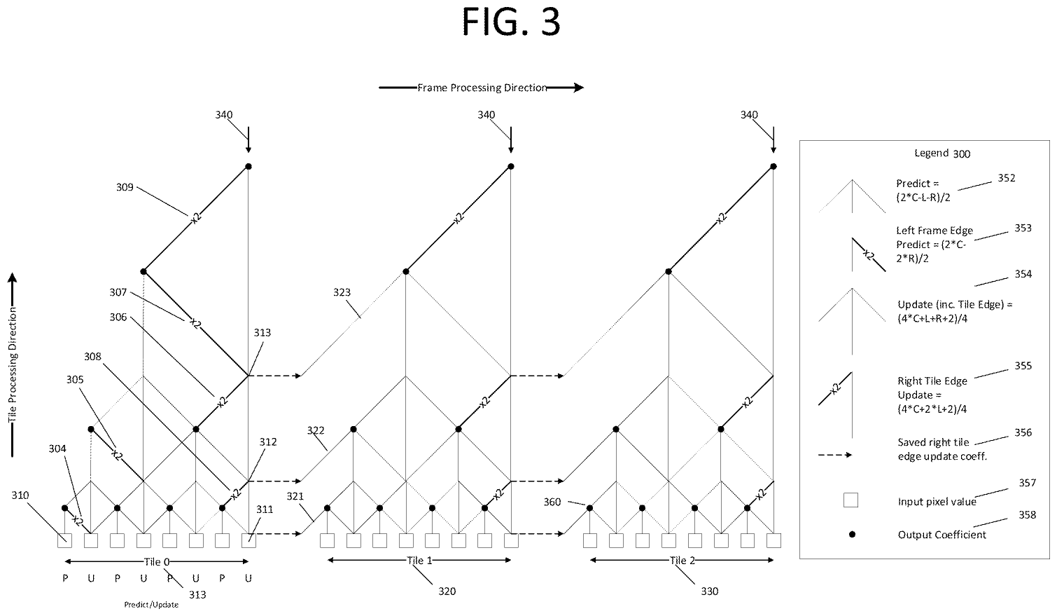

### FIG. 3 SOS Tile Encode

FIG. 3 illustrates a partial view of a three-layer wavelet decomposition for an exemplary pixel row dissection across three 8-pixel by 8-pixel size tiles in accordance with one or more embodiments of the present invention. Those skilled in the art would see how this partial view, which depicts one dimension of the two-dimension wavelet transform, could be expanded to two-dimensional tiles of any power of two dimensions including a typical 64×64 pixel tile.

In detail, legend 300 identifies filters used in encoding pixel values 357, including pixel value 310, with encoding filters of a Cohen-Daubechies-Feauveau (CDF) reversible 5/3 filter (in other embodiments, other encoding filters may be used). Each filter element can be identified in FIG. 3 by matching a drawing in the legend 300 with a corresponding shape in the filter drawing.

Those skilled in the art would recognize the wavelet transform reflecting 309 on a right tile boundary 340 of each tile. A difference is on the left side of the tiles, where tile edge wavelet transforms 321, 322 and 323 uses either a saved transform result 312 and 313, or an input 311.

Trailing tile side intermediate wavelet-generated update coefficients 312 and 313 and input 311 are saved and used as inputs into tile side predict wavelet transforms 321, 322 and 323 of the adjacent tile's wavelet transforms predict filters as identified by 356 of FIG. 3.

Legend 300 identifies a name, shape and formula of each filter as well as pixel inputs (357), coefficient transfer between tiles (356). and coefficient outputs (358). In particular, filter 352 is a standard 5/3 predict filter where C, R and L in the legend identify the center, right and left coefficients respectively. Filter 353 is a left frame edge predict filter where a left coefficient is removed and a right coefficient is doubled. Filter 354 is a standard 5/3 update filter. Filter 355 is a right tile edge update filter where a right coefficient of a 354 filter is removed, and a left coefficient of the 354 filter is doubled. Legend item 356 identifies a saving of a right tile edge intermediate coefficient of a filter 355; the saved intermediate coefficients for a particular tile will then be used in an adjacent tile encoding by a 352 filter when the adjacent tile is encoded.

In detail, pixel 310 is a pixel on the leading (left) edge of source image 140 participating in a CDF reversible 5/3 filter where pixel value 304 (which becomes a coefficient in the filter) is doubled (i.e. reflected at the image edge as represented by the “x2”) to account for the missing pixel outside the image that would otherwise participate in the filter. Similarly, pixel values 305 and 307 are also doubled to account for missing pixels outside the frame.

Unlike standard continuous wavelet transforms, in the techniques described herein every tile is reflected in the encode direction and the lifting is terminated on each tile boundary (similar to isolated tile encoding, but with additional operations). Tile 0 pixel values 304, 305, 306, 307, 308 and 309 are doubled before use to account for missing pixel values outside each side of Tile 0; this Tile 0 encoding is consistent with standard isolated tile 5/3 CDF lifting, with the exception that intermediate coefficients 312 and 313 and pixel value 311 are saved for encoding the adjacent following tile (Tile 1) in an image transform of source image 140.

Once the encoding of Tile 0 is complete, Tile 1 is then encoded. The encoding of Tile 1 is similar to the encoding Tile 0 except, instead of using doubled coefficient values of a pixel on the left (trailing) edge of Tile 1, the saved pixel value 311 (i.e., the previous tile's right-edge pixel) and the intermediate wavelet-generated update coefficients 312 and 313 of Tile 0 are used respectively in the CDF predict filters 321, 322 and 323. The remainder of Tile 1 encodes the same as the Tile 0, saving right edge intermediate update results to be used in the encoding of Tile 2.

The encoding of Tile 2 is analogous to the encoding of Tile 1, with the right-most pixel value from Tile 1 and the intermediate update coefficients generated during the wavelet encoding of Tile 1 being used in the encoding of Tile 2. This process is repeated until the end of the frame is reached. In some embodiments, as is known in the art, the frame may not be an exact multiple of a tile width or height. In such embodiments, any of numerous techniques of solving this problem may be used, with the most common being edge pixel duplication until an integer multiple of tiles is reached.

In certain embodiments, the output coefficients 358 of the wavelet decomposition are decoded without change to produce a lossless reconstruction of the encoded image. In other embodiments, these coefficients are quantized and/or compressed for saving and/or transmission.

The exemplary single tile row encoding method described above may be translated into a two-dimensional frame encoding method, creating two leading tile sides for each tile that generate tile edge coefficients 356 for adjacent tiles in both leading tile edge directions. While the tile order is typically a raster order, any order that ensures each of two adjacent tile sides of an encoding tile are adjacent to either a frame edge or a previously encoded tile will work.

Variations on tile encoding sequencing will allow concurrent (e.g. multi-threaded) encoding where each tile row is processed by a different thread, as long as it is confirmed for each tile that the above tile is encoded before proceeding. In another embodiment, encoding may start from each of the four corners of a frame.

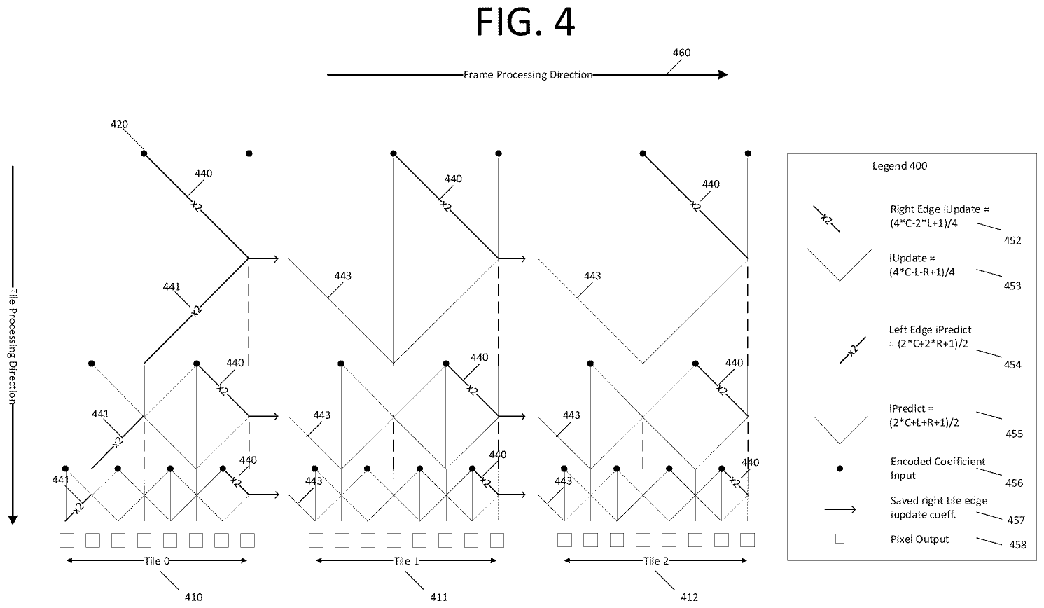

### FIG. 4 SOS Tile Decode

Analogous to FIG. 3, FIG. 4 illustrates a partial view of a three-layer wavelet composition for an exemplary pixel row dissection across three 8-pixel by 8-pixel size tiles in accordance with one or more embodiments of the present invention. Those skilled in the art would see how this partial view, which depicts one dimension of the two-dimension wavelet decoding, could be expanded to two-dimensional tiles of any power of two dimensions including a typical 64×64 pixel tile.

Before transforming encoded coefficients back into the spatial domain with the inverted transform, the coefficients are inverse-quantized if they have been quantized.

As depicted in FIG. 4, CDF reconstruction filters (referred to herein as “inverted update” and “inverted predict” or “Update” and “iPredict” respectively) are used to decode the wavelet-encoded coefficients. In detail, legend 400 identifies decoding filters of a CDF reversible 5/3 filter and shows for each filter both a drawing shape and a formula, where the letters R, C and L in the formulas identify right, center and left coefficients respectively. Each filter can be identified in FIG. 4 by matching each drawing in the legend 400 with a corresponding shape in the filter drawing. Legend 400 also identifies shapes of encoded coefficient inputs 456, coefficient transfers between tiles (i.e., right tile edge iupdate coefficients 457), and pixel outputs 458.

Those skilled in the art would recognize doubling iUpdate coefficients, 440, on each right tile edge as a result of the tiling interrupting an iUpdate transform. Coefficient doubling, 441, is also used on the left frame edge where inter-tile transforms are interrupted.

One difference between the decoding technique depicted in FIG. 4 and a standard CDF 5/3 reconstruction is between tiles, where tile edge interim transform results of right tile edge iUpdate filters 452 (440) are saved (shown by arrows 457) and used as input to left tile edge iUpdate filters 443.

Tile edge interim coefficients (which may also be referred to as tile side intermediate inverted update coefficients) generated by a first tile and used by an adjacent second tile, as shown by arrows 457, are also saved between frames as saved interim coefficients (which may also be referred to as saved intermediate inverted update coefficients). These saved interim coefficients are then used by the second tile in following frames while the first tile remains unchanged and whenever the second tile changes.

Filter 453 is an iUpdate filter without tile edge reflection.

Filter 454 is a left tile edge iPredict filter where the right coefficient is doubled (reflected) to account for the absent left coefficient.

Filter 455 is an iPredict filter without edge reflection.

Encoded coefficient input 456 identifies where encoded coefficients are inserted into the inverted transform.

Saved right tile edge update coefficients 457 identifies a saving and transfer of an interim CDF decode coefficient that is saved in one tile decode to be used in the adjacent tile decode. The use may be during the frame decode when the coefficient is generated or in a subsequent frame when the tile that generated the coefficient and the coefficient are unchanged and the tile receiving the coefficient is updated.

Pixel value output 458 identifies a completed transform of the encoded coefficients to generate an output pixel for display 122.

### Neighboring Tile Updates

By following the filter pattern shown by FIGS. 3 and 4, it can be seen that changes to a single input pixel will losslessly be reproduced by the decoder, but only if the encoded coefficients are not quantized or otherwise encoded with a lossy encoding method.

However, changes in one tile can propagate to an adjacent following tile in the frame processing direction 460. This propagation occurs on both the encode and decode so a single pixel change requires encoding and decoding a square of 3×3 tiles to correctly update the encoder and decoder reference data and output image for a change of a single pixel (although, in embodiments where only Tile 0 changes out of Tiles 0-2, it's not required to re-encode Tile 2 as the change in Tile 0 will only change the encoded data of Tiles 0 and 1, and it isn't until the decode is done that the Tile 0 change will propagate to Tile 2). While an encode wavelet transform will propagate a change into the next tile, the decode will propagate the change into the following tile. With a 2D image this results in having to encode and decode a square of 3×3 tiles to properly filter the image change.

### Selective Tile Updates

By using the SOS wavelet codec (which comprises the wavelet transform and coefficient suppression module 164 and the decoder 124), described herein, to encode and decode image frames, any combination of unchanged and changed image tiles can be updated with each tile using shared coefficients with adjacent tiles.

For example, a dragging of a small object image across display 122 would result in updating a limited number of tiles around the object as it moves across the display.

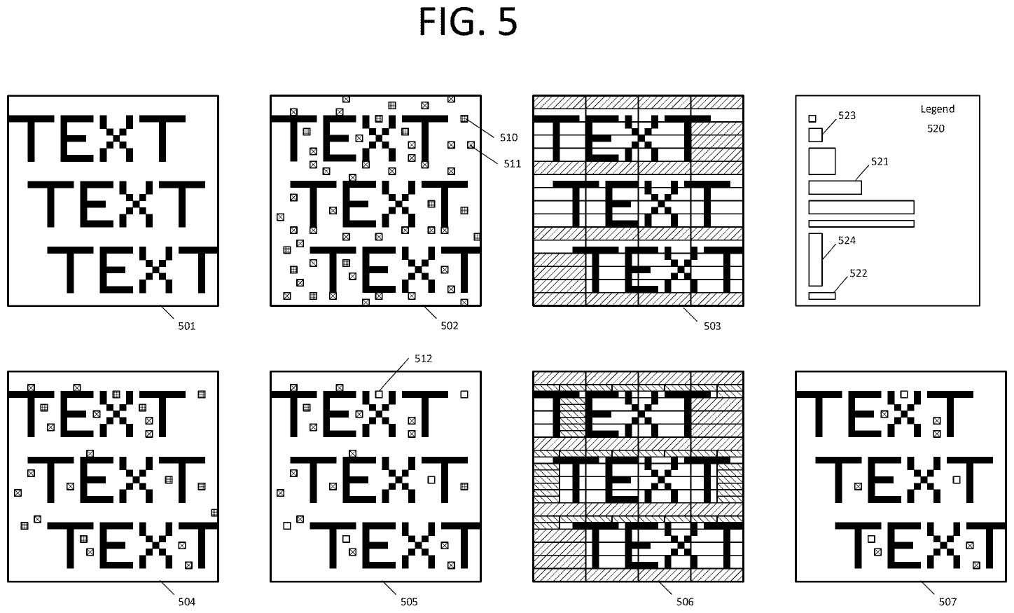

### FIG. 5 Text Encoding

As previously presented, lossless encoder 170 is used for encoding text images. This presents to the user a very clear text image at the expense of processing time and high network bandwidth. In some applications this is the correct solution, where nothing is presented until a high-quality image is presented. For example, paging though a text document, where delaying a frame update for 4 frame counts is acceptable. However, if a video is also playing at the same time at a full display frame rate (e.g. 60 fps), stalling the video for 4 frames, including dropping video frame updates may not be acceptable.

In embodiments where full frame rate (e.g. 60 fps) interactivity must be maintained, while presenting complex, high contrast stationary text, an alternative encoding method may be used. The objective is to present as clean of text as possible, while maintaining updates at the full frame rate and working within the network and processing bandwidth limits. By first presenting the best image possible in the changed image frame, and then building the quality of the image as quickly as possible, while working within the network and processing limitations, a clean image can be presented to the user with minimal observation of the initial image change artifacts. However, this requires image codecs that are processing efficient, i.e. user vector processing, and are tunable such that they can be adjusted to use the available network and processing bandwidth.

The SOS wavelet video codec (which comprises the wavelet transform and coefficient suppression module 164 and the decoder 124) previously presented meets these requirements. As the quantization is increased the amount of network and processing bandwidth is decreased. Processing bandwidth is reduced as there is less data to pack and transmit over the network. In an embodiment the SOS wavelet video codec can also be set to not quantize or transmit high frequency output coefficients 358; for example, coefficient 360 shown in FIG. 3. These high frequency coefficients are typically zero at low quality settings, so quantizing and packing zero data for transmit only wastes processing bandwidth. With analysis, it can be determined at what image quality performing these operations can be skipped.

An issue with encoding high frequency image content like text with a lossy video codec is the artifacts that are generated in the decoded image. With most, or all the high frequency content removed, quantization errors and Gibbs artifacts are obvious and objectional. These artifacts are why lossless encoding is often used on text.

An alternative is to use the lossy image video codec image (SOS codec) and clean up the artifacts/errors to make them less noticeable until the artifacts can be further removed by a quality build of the following frame. The improvement may then be repeated in subsequent frames until a near lossless or lossless image is presented.

FIG. 5 depicts an efficient and bandwidth-tunable method of cleaning up a lossy encoded text image in accordance with one or more embodiments of the present invention.

Image 501 is an example of a 32×32 pixel image tile with a text image to be communicated, decoded and then cleaned up.

Image 502 is an example of artifacts generated by quantization when wavelet encoding the image 501. Typically, there are two types of errors: text color pixel errors 511 appearing in the background and distorting the text image shape, and less often but more noticeable chroma/color errors 510.

The most effective cleanup of the image 502 is to clean up the background. This first requires identifying the background color of the source image 501, which, in some embodiments, may be achieved by comparing and counting random or patterned pixel pair matches to determine the most common pixel matching color. This can be processed quickly with vector processing.

Next, with the background colour selected, is to identify pixels with this background color. To simplify this identification and decrease the processing time and the communication size of the background pixels, a background grid chunk size from legend 520 is selected, e.g. 521 (e.g. a horizontal chunk mask) is selected from a range of possible grid chunk sizes examples shown in the legend 520.

Once again, vector processing efficiently identifies which chunks of the size 521, of the background grid of chunks are solid background colour as shown in 503 in the source image 501. A list of background chunk positions and background color are communicated along with the wavelet-encoded image and used to clean up the decoded wavelet image to generate image 504. A simple way to transmit the list is to transmit a 1 or 0 for each chunk in a tile. Other methods might further compress this by binary encoding. A binary value of 1 bit per chunk in raster order can efficiently identify which chunks are entirely the background color. This same chunk color analysis can also be used to assist in text detection.

A second cleanup of image 501 is to minimize chroma errors 510, caused by quantizing high-contrast images like text 501. These chroma errors 510 can be reduced by determining the maximum and minimum colour values of all pixels of a tile, in either or both RGB and/or YUV color space, then sending these maximum and minimum colour values to the client and restricting (clamping) all decoded pixel colors to the color ranges defined by these maximum and minimum color values. Once again, these values can be determined quickly with vector processing. Also, these color limits do not need to be communicated at full precision to provide visible improvements in the decoded image.

This color clamping can be very successful at reducing errors of text on a colored background where Gibbs effects are most noticeable. Gibbs effects are less noticeable on a saturated background color such as a white background. Note that color clamping does not normally produce a lossless pixel value but can noticeably reduce the visibility of an error 512 of tile 505.

As this background masking and color clamping can be losslessly encoded and are based on the unquantized input image, the masking and clamping values can be used for the same tile on multiple frames while the input image is constant, keeping the errors minimized as the decoded tile image is replaced by progressive higher quality encodings of the underlying wavelet decoded tile image.

A second advantage, or opportunity, is that since this background masking and clamping is lossless and will not generate errors, it can be used on any content. Thus, misidentifying content as text and clamping it will not generate errors. It may also be useful to enable when an input tile RGB or YUV range is limited. For example, wavelet encoding a high contrast but not full range RGB image can result in ringing and overshooting the original RGB range of the input image. If the input image is tested for maximum and minimum RGB values and transmits them along with the quantized Y, U and V data, any R, G, B overshooting can be clamped to the RGB limits of the original image, removing the most objectionable image ringing artifacts, not removed by the chunk mask. Once the initial decoding of a changed tile is completed 504, an update to the mask can be generated on a following frame. By dividing initial chunks of the grid of chunks of size 521 that have not been identified as background colour into a smaller size four chunks, each having the size 522 (as shown in the legend 520) and encoding which of these 522 size chunks are background color 506, more of the background can efficiently be cleaned up to produce a better decoded image 507. This process can take place over multiple frames to stay within the limits of the communication bandwidth, while common algorithms used by the encoder and decoder, work to partition and identify remaining portions of each tile that have not be identified a either all text (image) or all background.

Subdividing of chunks in combination with reduced quantization of wavelet encoded data is repeated to increase the image quality, but at some point, the image quality of the wavelet data will be sufficient to disable the clamp and mask and only use the wavelet decoded image, typically with a lossless wavelet encoded update.

Given that all text images are not the same, while a horizontal chunk mask such as mask 521 is very good with typical horizontal text, it may not be the best mask for a table with vertical grid lines where chunk mask 523 might be better (shown in the legend 520). As any mask can be used without making the decoded image worse than no mask being used, the encoder can test multiple mask resolution to determine which mask catches the greatest number of pixels when compared to the size of the mask encoding bit co. This mask testing can be performed multiple times on one tile of one frame or tested on different tiles as each tile is encoded. The encoder can also track if a tile's mask efficiency changes as the tile progresses though multiple frames and test and change the mask accordingly.

As the uncompressed mask costs of the described mask is relatively small and it is desired to keep processing time to a minimum, further compressing the masks may not beneficial. However, if the image codec determines there is additional processing bandwidth available compressing the mask with a binary arithmetic encoder (BAC) is possible. Using a BAC should be weight against testing other encoding options such as partitioning tiles into multiple sub tiles so multiple mask resolutions can be used.

As described above this mask and clamp method of improving high contrast images like text is useful to provide cleaner text in combination with high frame rate constantly changing content like video. By identifying that the image content is mostly static, it may better to dynamically switch to the direct to lossless text codec as this codec's delay is less noticeable and the image is initially better.

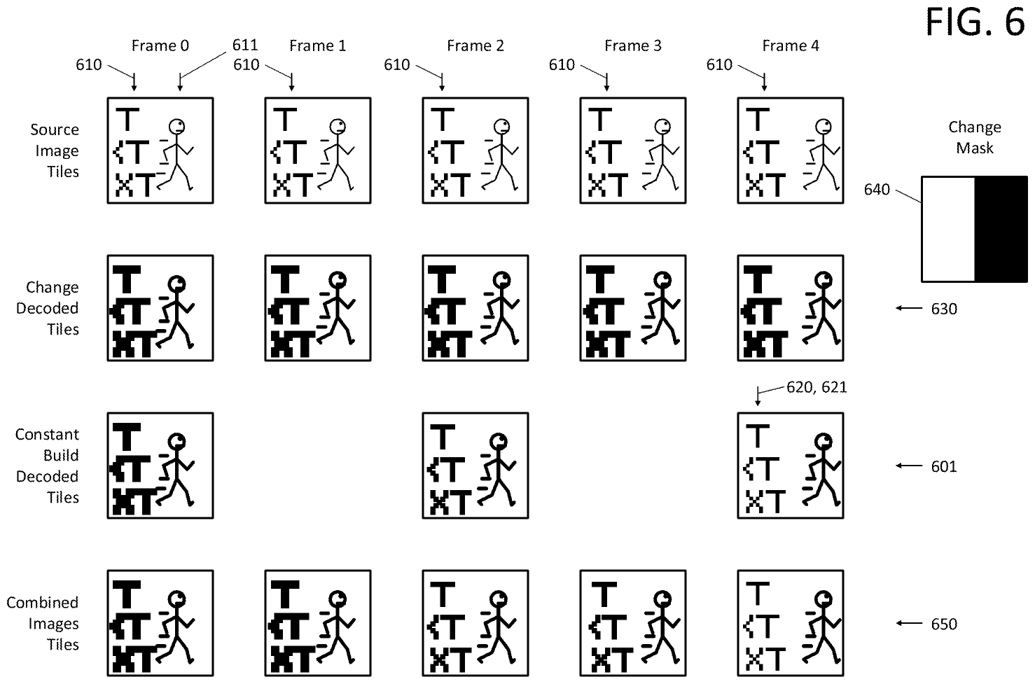

### FIG. 6 Mixed Tile Encoding

FIG. 6 illustrates a mixed content tile with building to lossless unchanged content with changing content in accordance with embodiments of the present invention. FIG. 6 depicts a series of source image tiles, a series of change decoded tiles, a series of constant build decoded tiles, and a series of combined image tiles, as well as a change mask 640.

As previously presented, in various embodiments the lossy encoder 160 and lossless encoder 170 may be the same codec. In such embodiments, lossless encoding typically comprises encoding, transmitting and decoding progressive layers of increased image quality quantization 601, or at once without quantization, of a tile with constant source image content 610, to generate decoded constant images of the tile, until a lossless image 620, or a maximum quality level image 621, of the tile is transmitted and decoded to generate a constant image decoded tile.

However, if the tile has both constant content 610 and changing content 611, a change encoding of the tile is also typically encoded, transmitted and decoded at the change quantization level 630, each time the image changes to generate a changing image decoded tile.

Along with the change and/or increased quality encoding, a change mask 640 identifying a boundary between the changing and constant image content is typically transmitted when the boundary changes.

The decoder 124 then assembles an output tile image 650 from the constant image decoded tile 601, the changing image decoded tile 630 and the change mask 640. This assembly occurs every time one of the constant image decoded tile 601, the changing image decoded tile 630 or the change mask 640 is updated.

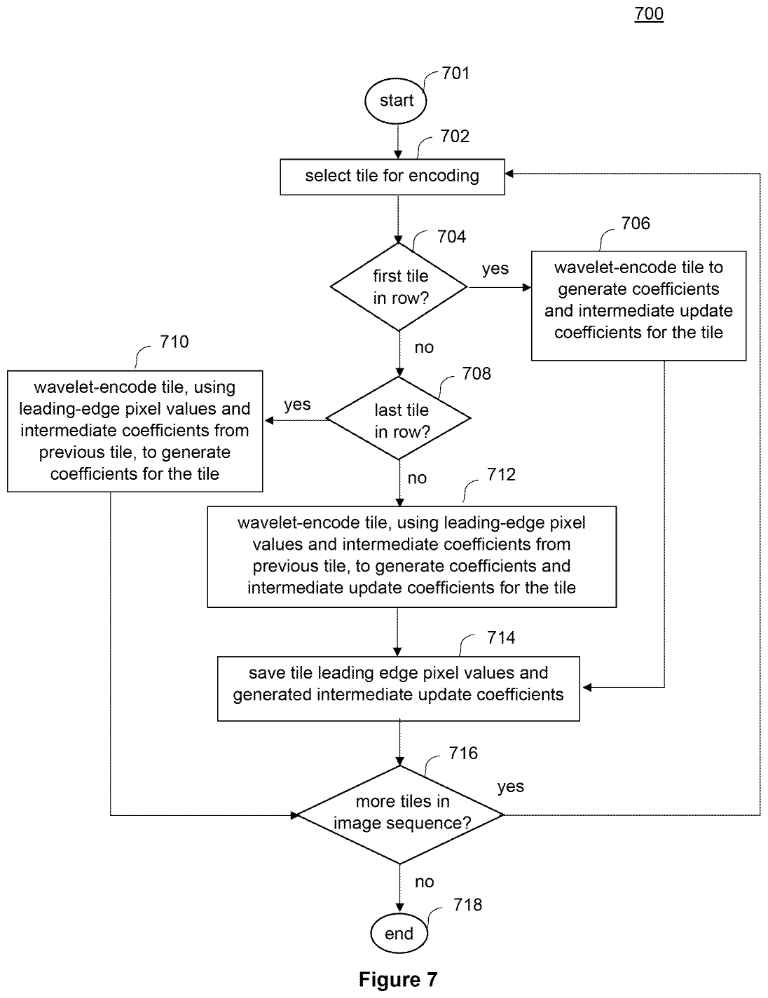

FIG. 7 is a flow diagram of a method 700 for encoding an image sequence in accordance with embodiments of the present invention. The method 700 is described for one dimension of the two-dimensional wavelet transform (e.g., as shown in FIG. 3), and may be expanded to two-dimensional tiles of any power of two dimensions, such as a typical 64×64 pixel tile. In one or more embodiments, the method 700 is an implementation of the wavelet transform and coefficient suppression module 164. In certain embodiments, a computer readable medium comprises a program that, when executed by a processor, performs the method 700 described below.

The method 700 starts at step 701 and proceeds to step 702. At step 702, an image tile of a source image is selected for encoding. Generally, the tiles are processed in a raster order, although any order that ensures each of two adjacent tile sides of an encoding tile are adjacent to either a frame edge or a previously-encoded tile may be used. At step 704, a determination is made whether the selected image tile is the first tile (i.e., the left-most tile) in the tile row in which it resides. If the result of the determination is yes, the method 700 proceeds to step 706. At step 706, the tile is wavelet-encoded, using a boundary process to fill regions participating in the wavelet transform but outside of the image frame. The boundary process fills these regions with coefficient data that minimizes the size of the encoded data set while also allowing the transform to proceed with the same steps as when a full image is processed. In some embodiments, such as the embodiment described with respect to FIG. 3, edge reflection at the tile's trailing edge is used. The wavelet encoding of the tile generates wavelet-encoded coefficients for the tile, as well as intermediate wavelet-generated update coefficients. The method 700 proceeds to step 714, where the wavelet-generated update coefficients are saved for use in encoding subsequent tiles.

If, at step 704, the result of the determination is no, that the tile is not the first tile in the row, the method 700 proceeds to step 708 where a determination is made whether the tile is the last tile (i.e., the right-most tile) in the row in which it resides. If the result of the determination is no, that the tile is not the last tile, the method 700 proceeds to step 712. At step 712, the tile is wavelet-encoded using the leading-edge pixel value from the previous tile, plus the wavelet-generated update coefficients from the previous tile. The wavelet encoding of the tile generates wavelet-encoded coefficients for the tile, as well as intermediate wavelet-generated update coefficients for the tile. The method 700 proceeds to step 714, where the wavelet-generated update coefficients are saved for use in encoding the following tile.

The method 700 proceeds from step 714 to step 716, where a determination is made whether the end of the source image has been reached. If the result of the determination is no, the next tile in the sequence will be processed and the method 700 returns to step 704.

If, at step 708, the result of the determination is yes, that the tile being processed is the last tile (i.e., the right-most tile) in the row in which it resides, the method 700 proceeds to step 710. At step 710, the tile is wavelet-encoded using the leading-edge pixel value of the previous-adjacent tile, plus the wavelet-generated update coefficients from the previous-adjacent tile. The method 700 then proceeds to step 716.

At step 716, a determination is made whether there are any additional tiles to be processed. If the result of the determination is yes, the method 700 returns to step 702 where the next tile for processing is selected. If the result of the determination is no, the method 700 proceeds to step 718 where it ends.

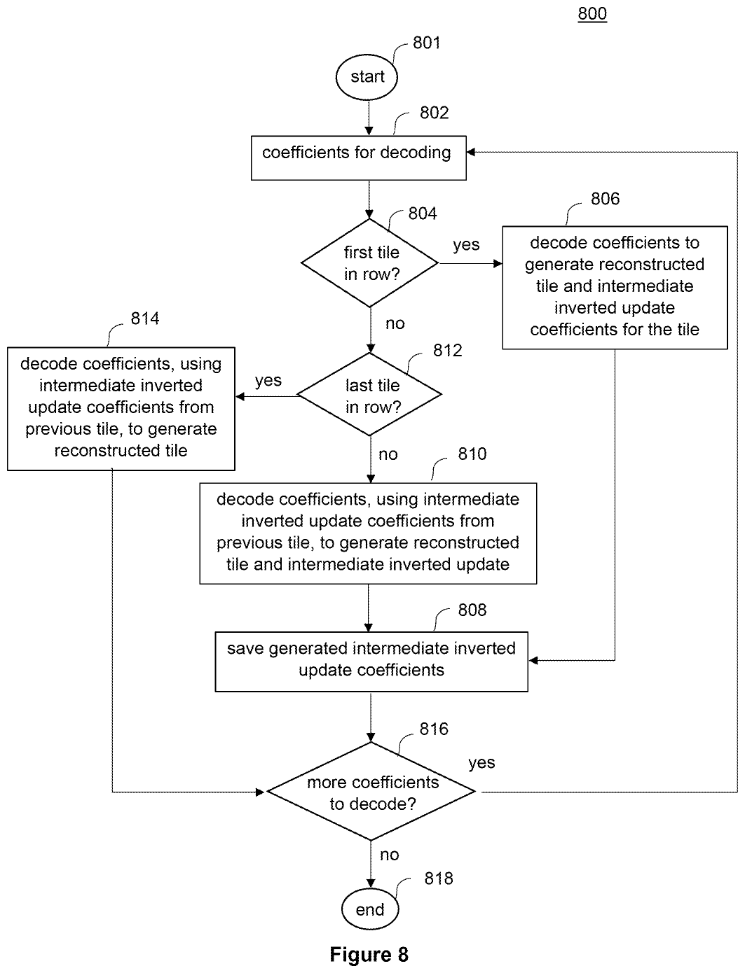

FIG. 8 is a flow diagram of a method 800 for decoding an encoded image sequence in accordance with embodiments of the present invention. The method 800 is described for one dimension of the two-dimension wavelet transform (e.g., as shown in FIG. 4), and may be expanded to two-dimensional tiles of any power of two dimensions, such as a typical 64×64 pixel tile. In one or more embodiments, the method 800 is an implementation of the decoder 124. In some embodiments, a computer readable medium comprises a program that, when executed by a processor, performs the method 800 described herein.

The method 800 starts at step 801 and proceeds to step 802. At step 802, the wavelet-encoded coefficients corresponding to a tile of an image sequence are received. The method 800 proceeds to step 804, where a determination is made whether the received coefficients are for the first image tile (i.e., the left-most tile) in a tile row. If the result of the determination is yes, the method 800 proceeds to step 806.

At step 806, the received coefficients are decoded. The coefficients are decoded using inverted wavelet filters corresponding to those used in the encoding, with a boundary process (corresponding to the one used in encoding) used for decoding the trailing (i.e, left) edge of the tile. The decoding generates a reconstructed tile along with intermediate inverted update coefficients for the tile. The method 800 proceeds to step 808, where the intermediate inverted update coefficients are saved for use in reconstructing subsequent tiles. The method 800 then proceeds to step 816, described further below.

If, at step 804, the result of the determination is no, that the wavelet-encoded coefficients are not for the first tile in the row, the method 800 proceeds to step 812. At step 812, a determination is made whether the wavelet-encoded coefficients are for the last tile (i.e., the right-most tile) in the row. If the result of the determination is no, the method 800 proceeds to step 810.

At step 810, the wavelet-encoded coefficients are decoded using the intermediate inverted update coefficients from the previous-adjacent tile, to generate a reconstruction of the tile as well as intermediate inverted update coefficients for the tile. The method 800 proceeds to step 808, where the generated intermediate inverted update coefficients are saved.

If, at step 812, the result of the determination is yes, that the encoded tile to be decoded is the last tile (i.e., the right-most tile) in the row, the method 800 proceeds to step 814. At step 814, the wavelet-encoded coefficients are decoded, using the intermediate inverted update coefficients from the previous-adjacent tile, to generate a reconstruction of the tile. The method 800 proceeds to step 816.

At step 816, a determination is made whether there are additional coefficients (i.e., encoded tiles) to be decoded. If the result of the determination is yes, the method 800 returns to step 802; if the results of the determination is no, the method 800 proceeds to step 818 where it ends.

### Exemplary Embodiments

1. A method of encoding an image, comprising:

encoding, using a tiled Cohen-Daubechies-Feauveau (CDF) filter, a plurality of tiles of the image, wherein update step results of one tile edge of a first tile of the plurality of tiles are used as inputs to a predict step of an adjacent tile edge.

2. The method of embodiment 1, wherein the adjacent tile is to the right of the first tile; and wherein update step results of a bottom edge of the first tile are used as inputs to a predict step of a lower-adjacent tile edge, the lower-adjacent tile below and adjacent to the first tile.
3. The method of embodiment 1, wherein encoding the plurality of tiles comprises using all leading tile edge coefficients in encoding of the following adjacent tile.
4. The method of embodiment 1, wherein, the encoding comprises reflecting, in the encode direction, every tile in the plurality of tiles; and terminating lifting on each tile boundary.
5. The method of embodiment 1, further comprising, when content of the first tile remains unchanged in a subsequent frame of the image, using the update step results of the one tile edge to encode at least one tile of the subsequent frame of the image.
6. The method of embodiment 5, wherein content of the at least one tile of the subsequent frame is changed from the previous frame.

### Exemplary SOS Method

A method of encoding and decoding an image, comprising:
1. Define a tile size as a power of 2 pixel height and width (e.g. 64 pixels).
2. Define an integer frame tile width=(image pixel width+tile size−1)/tile size.
3. Define an integer frame tile height=(image pixel height+tile size−1)/tile size.
4. Define a pixel zero “image origin corner” as the horizontal and verticle predict top left coefficient.
5. Expand the image to an integer tile width frame and an integer tile height with image edge pixel duplication that duplicates image edge pixels out to the frame edge pixels.
6. Encoding, using a Cohen-Daubechies-Feauveau (CDF) reversible filter transform, each tile, comprising:
encoding, using the Cohen-Daubechies-Feauveau (CDF) reversible filter transform on a first tile of a tile row of an image frame, in isolation of other tiles, to generate first tile wavelet-encoded coefficients comprising first trailing tile side intermediate wavelet-generated update coefficients, wherein the first tile is a corner tile of the image frame;
encoding a second tile, having at least one side adjacent to the first tile, using the first trailing tile side intermediate wavelet-generated update coefficients as inputs to tile side predict wavelet transforms of the second tile to generate second tile wavelet-encoded coefficients.
   7. Decoding the encoded image, comprising:
decoding the first tile wavelet-encoded coefficients to regenerate a version of the first tile of the image frame and generate first tile side intermediate inverted update coefficients; and
decoding the second tile wavelet-encoded coefficients in combination with the first tile side intermediate inverted update coefficients to regenerate a version of the second tile of the image.

Furthering comprising identifying that the second tile has changed and re-encoding the second tile using the first tile side intermediate wavelet-generated update coefficients as inputs to tile side predict wavelet transforms of the second tile.

Exemplary SOS Decoder method example 1

A method of decoding an encoded image sequence comprising:
decoding wavelet-encoded coefficients of a first image tile of a first source frame to generate a first frame of an image sequence; and
decoding wavelet encoded coefficients updates of a second image tile of a second source frame to generate a second frame of the image sequence;
wherein decoding the wavelet encoded coefficients updates comprises using a saved intermediate decoded coefficient of a tile edge of the first image tile.
Wherein the saved intermediate decoded coefficient is a result of a tile edge inverse discrete wavelet transform update.

### Exemplary SOS Decoder Method Example 2

A method of decoding an encoded image sequence comprising,
receiving and decoding wavelet encoded coefficients of first and second image tiles of a first frame of a source image to generate a first frame of an image sequence,
receiving and decoding wavelet encoded coefficients updates of a second image tile of a second frame of the source image to generate a second frame of the image sequence,
wherein decoding the first wavelet encoded coefficients updates comprises using a saved intermediate decoded coefficient of a tile edge of the first image tile.
Wherein the saved intermediate decoded coefficient is a result of a tile edge inverted discrete wavelet transform update.

### Exemplary SOS Decoder Method Example 3

A method of decoding an encoded image sequence comprising,
Receiving and decoding first encoded wavelet coefficients, corresponding to a first tile of a first frame of a source image, to generate a first reconstructed tile of a first frame of a reconstructed image;
Receiving and decoding second encoded wavelet coefficients, corresponding to a second Tile of the first frame of the source image, to generate a second reconstructed tile that is adjacent to the first reconstructed tile;
wherein decoding the second encoded wavelet coefficients to generate an edge of the second reconstructed tile that is along an edge of the first reconstructed tile comprises using a saved intermediate decoded coefficient corresponding to the edge of the first reconstructed tile.
wherein, when the first tile has changed in a subsequent frame, decoding of the second tile can come from data from first Frame except intermediate data along tile edge.

### Exemplary SOS Encoder Method Example 1

A method of encoding a sequence of image frames comprising:

dividing, for each frame of the sequence of image frames, the frame into a spatially-consistent grid of tiles comprising first and second tiles adjacent to one another in a tile row of the frame;

encoding pixel data of the first and the second tiles of a first frame of the image frames to generate a first frame first tile encoding and a first frame second tile encoding;

encoding the first tile of a second frame of the sequence of image frames as unchanged in response to identifying the first tile of the second frame is constant;

identifying the second tile of the second frame has changed; and

encoding the second tile of the second frame using previously-encoded coefficient data of the first tile of the first frame.

### Exemplary SOS Encoder Method Example 2

A method of communicating a sequence of image frames between an image source computer and an image destination computer comprising:

dividing, by the image source computer, pixels of each frame of the sequence of image frames into a spatially-consistent grid of tiles comprising spatially-adjacent first and second position tiles;

encoding, by the image source computer, the first position tile of a first frame of the sequence of image frames, using a two-dimensional discrete wavelet transform, in isolation of the second position tile in the first frame, to generate first tile coefficients plus at least one first position tile intermediate coefficient;

encoding, by the image source computer, the second position tile of a second frame of the sequence of image frames, using the two-dimensional discrete wavelet transform and the at least one first position tile intermediate coefficient, to generate second tile coefficients;

compressing the first and second tile coefficients to generate image data;

communicating the image data to the image destination computer;

decompressing, by the image destination computer, the image data to generate first and second tile decoder coefficients;

decoding, by the image destination computer, the first tile decoder coefficients, in isolation of the second position tile of the second frame, using a two-dimensional inverted discrete wavelet transform, to obtain a first decoded tile and a first tile intermediate coefficient;

decoding, by the image destination computer, the second tile decoder coefficients and the first tile intermediate coefficient using the two-dimensional inverted discrete wavelet transform, to obtain a second decoded tile; and

displaying, by the destination computer, the first and second decoded tiles.

Where compressing the first and second tile coefficients comprises quantizing the first and second tile coefficients.

Wherein the intermediate coefficient is a low pass coefficient of the leading edge of the DWT at the tile edge between the first and second tiles.

Wherein the at least one first tile intermediate coefficient comprises a discrete wavelet transform intermediate value prior to replacement by subsequent execution of the 2-dimensional wavelet transform.

Wherein on a subsequent frame the first tile remains unchanged and the second tile changes and encoding the second tile using the first tile coefficient of the previous frame.

### Exemplary SOS Additional Embodiments

2. The method of embodiment 1, wherein, for each tile of the spatially-consistent grid of tiles, encoding pixel data of the tile comprises performing a 2-dimensional discrete wavelet transform on spatial domain image data of the tile to generate encoded coefficients.
3. The method of embodiment 2, wherein encoding the tile requires the top and the left side of the tile touching a frame edge or a previously encoded tile of the frame.
4. The method of embodiment 3, wherein a plurality of tiles are encoded concurrently.
5. The method of embodiment 2, further comprising saving leading tile edge intermediate coefficients of the 2-dimensional discrete wavelet transform of a third tile as tile edge coefficients; and using, when the third tile is unchanged in a subsequent frame, the tile edge coefficients when encoding an adjacent following fourth tile in the subsequent frame.
6. The method of embodiment 1, further comprising, for each frame of the sequence of image frames, prior to dividing the frame into the spatially-consistent grid of tiles, padding, with distortion minimizing image data, the right and bottom edges of the frame to an integer multiple of a tile size of the 2-dimensional discrete wavelet transform to make the frame an integer number of tiles wide and height.
7. The method of embodiment 1, further comprising, in response to a frame comprising a single tile changing with respect to a previous frame, encoding a square of four tiles with the single changed tile in the top left corner of the square.
8. The method of embodiment 1, wherein each tile of the spatially-consistent grid of tiles has the same power of 2 dimensions.
9. The method of embodiment 1, further comprising encoding a subsequent tile in isolation of other pixels of the image frame, wherein encoding the subsequent tile comprises using at least one encoded coefficient of a previously encoded tile adjacent to the subsequent tile.
10. The method of embodiment 1, wherein encoding the first tile comprises transforming the pixels of the first tile into frequency domain coefficients.
11. The method of embodiment 1, wherein a tile is at least 4 pixels high by 4 pixels wide and a power of 2 in width and height.

### Exemplary Text Decode Method

A method of decoding an encoded tile image, comprising:
receiving and decoding wavelet encoded coefficients to generate luminance and chrominance values of a tile image,
wherein the encoded wavelet coefficients are quantized and decoding comprised inverse quantization,
receiving maximum and minimum luminance and chrominance values and limiting the luminance and chrominance values of the tile image based on the maximum and minimum luminance and chrominance values,
converting the luminance and chrominance values to tile image red, green and blue values,
receiving maximum and minimum red green and blue values and limiting the red, green and blue values of the tile image to maximum and minimum red green and blue values,
and receiving and decoding a background color and a pixel mask and setting pixels of the tile image, identified by the pixel mask, to the background color.
wherein receiving the maximum and the minimum color values comprises receiving an indication to use the maximum and the minimum color values color values of a previously decoded tile,
wherein the previously decoded tile is one of the above spatially offset tile or the immediately previously decoded tile in a decoded tile sequence.
wherein receiving the wavelet encoding coefficients comprises receiving a quantization level of the wavelet encoded coefficients,
wherein pixel dimensions of rectangular blocks of the pixel mask are adjusted in response to changes in the quantization level,
wherein receiving a change in the quantization level that fragments the rectangular blocks of the pixel mask comprises receiving a mask supplement clarifying undefined fragments of the pixel mask.
   Identifying a chroma range of tile input image and restricting the chroma range of decoded pixel values, before converting to YUV to RGB.

1. A method of encoding an image, comprising:
encoding, using a tiled Cohen-Daubechies-Feauveau (CDF) filter, a plurality of tiles of the image, wherein update step results of one tile edge of a first tile of the plurality of tiles are used as inputs to a predict step of an adjacent tile edge.

2. The method of claim 1, wherein the adjacent tile is to the right of the first tile; and wherein update step results of a bottom edge of the first tile are used as inputs to a predict step of a lower-adjacent tile edge, the lower-adjacent tile below and adjacent to the first tile.

3. The method of claim 1, wherein encoding the plurality of tiles comprises using all leading tile edge coefficients in encoding of the following adjacent tile.

4. The method of claim 1, wherein, the encoding comprises reflecting, in the encode direction, every tile in the plurality of tiles; and terminating lifting on each tile boundary.

5. The method of claim 1, further comprising, when content of the first tile remains unchanged in a subsequent frame of the image, using the update step results of the one tile edge to encode at least one tile of the subsequent frame of the image.

6. The method of claim 5, wherein content of the at least one tile of the subsequent frame is changed from the previous frame.

7. A method of encoding a sequence of image frames, comprising:
encoding, using a two-dimensional discrete wavelet transform, a first tile of an image frame, in isolation of other tiles, to generate first tile wavelet-encoded coefficients comprising first trailing tile side intermediate wavelet-generated update coefficients, wherein the first tile is a corner tile of the image frame; and
encoding a second tile, having at least one side adjacent to the first tile, using the first trailing tile side intermediate wavelet-generated update coefficients as inputs to tile side predict wavelet transforms of the second tile to generate second tile wavelet-encoded coefficients.

8. The method of claim 7, wherein the two-dimensional discrete wavelet transform is a Cohen-Daubechies-Feauveau (CDF) reversible filter transform.

9. The method of claim 7, further comprising, encoding a tile in a subsequent image frame, the tile having the same position within the subsequent image frame as the second tile has within the image frame, using, when a tile that has the same position in the subsequent image frame as the first tile within the image frame is unchanged with respect to the first tile, the first trailing tile side intermediate wavelet-generated update coefficients.

10. The method of claim 7, wherein each tile in each image frame of the sequence of image frames is at least four pixels high by four pixels wide and has a width of a number of pixels that is a power of two and a height of a number of pixels that is a power of two.

11. A method of decoding an encoded image, comprising:
decoding first tile wavelet-encoded coefficients, using a two-dimensional inverted discrete wavelet transform, to generate a reconstructed first tile of an image frame and generate first tile side intermediate inverted update coefficients; and
decoding, using the two-dimensional inverted discrete wavelet transform, second tile wavelet-encoded coefficients in combination with the first tile side intermediate inverted update coefficients to generate a reconstructed second tile of the image frame, wherein the second tile has at least one side adjacent to the first tile.

12. The method of claim 11, wherein the two-dimensional discrete wavelet transform is a Cohen-Daubechies-Feauveau (CDF) reversible filter transform.

13. The method of claim 11, further comprising decoding, using the first tile side intermediate inverted update coefficients, second tile wavelet-encoded coefficient updates to generate a reconstructed second tile of a subsequent image frame.

14. The method of claim 11, wherein the first tile side intermediate inverted update coefficients correspond to an edge of the reconstructed first tile, the edge of the reconstructed first tile adjacent to an edge of the reconstructed second tile.
